(19) United States
(12) Patent Application Publication
(10) Pub. No.: US 2025/0123867 A1
(43) Pub. Date: Apr. 17, 2025

(54) LOCATION BASED FIREWALL POLICY FOR VIRTUAL DESKTOP INFRASTRUCTURE (VDI) SYSTEMS

(71) Applicant: Omnissa, LLC, Mountain View, CA (US)

(72) Inventors: James XIE, Beijing (CN); Yisan ZHAO, Beijing (CN)

(21) Appl. No.: 18/404,305

(22) Filed: Jan. 4, 2024

(30) Foreign Application Priority Data
Oct. 17, 2023 (WO) PCT/CN2023/124893

(51) Int. Cl. G06F 9/455

(52) U.S. Cl. CPC G06F 9/45558; G06F 2009/45587; G06F 2009/45595

(57) ABSTRACT

A method for implementing a firewall policy for a virtual desktop infrastructure (VDI) system comprising a data center hosting a pool of virtual desktops includes: assigning, a client device to a first virtual desktop included in the pool of virtual desktops hosted by the data center; obtaining data from the client device when the client device logs into the first virtual desktop; determining a location of the client device based, at least in part, on the data obtained from the client device, the location corresponding to a first network environment or a second network environment that is less secure than the first network environment; determining one or more firewall rules based, at least in part, on the firewall policy and the location of the client device; and generating a firewall for the data center based, at least in part, on the one or more firewall rules.

### CROSS-REFERENCE

This application is based upon and claims the benefit of priority from International Patent Application No. PCT/CN2023/124893, filed on Oct. 17, 2023, the entire contents of which are incorporated herein by reference.

### BACKGROUND

In a virtual desktop infrastructure (VDI) system, a client device may access and display a remote virtual or physical desktop or remote application that is running on a remote device (e.g, virtual machine). For instance, a virtual desktop may be hosted on a central infrastructure known as a VDI, and may be rendered on the client device using a remote display protocol. At the client device, a user may interact with the virtual desktop using peripheral devices (e.g., keyboard and mouse, pen, etc.) associated with the client device, and operating system (OS) events generated based on the user's inputs may be redirected from the client device to the remote device on which the virtual desktop is actually running.

The client device (e.g., laptop) may be issued to an individual (e.g., employee) associated with an organization or entity (e.g., company, university, government). In such instances, the individual may use the client device to connect to the virtual desktop from different network environments (e.g., home, office, airport, hotel, restaurant). For instance, the individual may use the client device to connect to the virtual desktop from a first network environment (e.g., office network) and a second network environment (e.g., non-office network) that is less secure than the first network environment.

Currently, VDIs may include a first pool of virtual desktops for the first network environment and a second pool of virtual desktops for the second network environment. Thus, a client device connecting to the VDI from the first network environment may be assigned one of the virtual desktops included in the first pool of virtual desktops, and a client device connecting to the VDI from the second network environment may be assigned one of the virtual desktops included in the second pool of virtual desktops. Furthermore, VDIs may include multiple firewall policies, one for each of the different pools (e.g., first pool and second pool) of virtual desktops. For instance, since the first network environment is more secure compared to the first network environment, a firewall policy for the first pool of virtual desktops may be less restricting compared to a firewall policy for the second pool of virtual desktops. VDIs having multiple pools of virtual desktops, each with its own firewall policy, to accommodate client devices connecting from different network environments increases the cost and complexity of implementing such VDIs.

Accordingly, there is a need in the art for an improved system and method for implementing a location based firewall policy for VDIs.

### SUMMARY

Aspects and advantages of embodiments of the present disclosure will be set forth in part in the following description, or may be learned from the description, or may be learned through practice of the embodiments.

A method for implementing a firewall policy for a virtual desktop infrastructure (VDI) system comprising a data center hosting a pool of virtual desktops includes: assigning, by the data center, a client device to a first virtual desktop included in the pool of virtual desktops hosted by the data center; obtaining, by the data center, data from the client device when the client device logs into the first virtual desktop; determining, by the data center, a location of the client device based, at least in part, on the data obtained from the client device, the location corresponding to a first network environment or a second network environment that is less secure than the first network environment; determining, by the data center, one or more firewall rules based, at least in part, on the firewall policy and the location of the client device, wherein the firewall policy specifies which of a plurality of software applications associated with the first virtual desktop are accessible from the location of the client device; and generating, by the data center, a firewall for the data center based, at least in part, on the one or more firewall rules.

Further embodiments include a non-transitory computer-readable storage medium storing instructions that, when executed by a computer system, cause the computer system to perform the method set forth above. Further embodiments include a system comprising at least one memory and at least one processor configured to perform the method set forth above.

The following description and the related drawings set forth in detail certain illustrative features of one or more embodiments.

### BRIEF DESCRIPTION OF THE DRAWINGS

FIG. 1 depicts a block diagram of a virtualized desktop infrastructure system in which one or more embodiments according to the present disclosure may be implemented.

FIG. 2 depicts a location based firewall policy for a virtual desktop infrastructure system according to some embodiments of the present disclosure.

FIG. 3 depicts a system for implementing a location based firewall policy for a virtual desktop infrastructure system according to some embodiments of the present disclosure.

FIG. 4 depicts a flowchart illustrating a method for implementing a location based firewall policy for a virtual desktop infrastructure system according to some embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure is directed to a VDI system hosting a pool of virtual desktops for an entity (e.g., company, university, government). The entity may issue a client device (e.g., laptops) to an individual (e.g., employees) of the entity, and the individual may use the client device to connect to the VDI system, specifically a virtual machine of the VDI system that is hosting the pool of virtual desktops. Once connected, the VDI system may assign the client device to a virtual desktop included in the pool of virtual desktops. The individual may then log into the virtual desktop to access software applications, one or more of which may have access to proprietary information (e.g., financial, sales, human resources, etc.) of the entity.

Example aspects of the present disclosure are directed to techniques for implementing a firewall for the VDI system based on a location of the client device connected to the VDI system. For instance, the firewall policy may require that certain software applications (e.g., those having access to proprietary information of the entity) of the entity may only be accessed (e.g., via a virtual desktop) by the client device from a first network environment (e.g., office network). The firewall policy may also indicate that certain software applications (e.g., those that do not have access to proprietary information of the entity) may be accessed (e.g., via a virtual desktop) by the client device from a second network environment (e.g., non-office environment) that is less secure than the first network environment. Examples of the second environment may include, without limitation, a hotel, a restaurant, a residential home, an airport, or any other suitable location having a wired or wireless network that may be joined by individuals (e.g., non-employees) that are not associated with the entity. More generally, the first network environment may be more secure than the second network environment, such as due to the first network environment being controlled by the entity that provided the client device to the user (e.g., and the second network environment being public and/or not being controlled by the entity) and/or the first network environment having more security policies configured and/or otherwise placing greater restrictions on access than the second network environment. For example, the first network environment may only be accessible by computing devices that are approved by the entity that controls the first networking environment, and may be behind a firewall and/or one or more other security mechanisms.

The client device may connect to the VDI system from the first network environment or the second network environment. Once connected to the data center, the client device may, as discussed above, be assigned one of the virtual desktops included in the pool of virtual desktops hosted by the virtual machine of the VDI system. Furthermore, when the individual logs into the assigned virtual desktop, the VDI system may obtain information identifying the client device. For instance, such information may include an internet protocol (IP) address of the client device.

The VDI system may include an application firewall manager configured to determine a location of the client device based on the information (e.g., IP address) identifying the client device. For instance, the application firewall manager may receive (e.g., in a JavaScript Object Notation format) the information (e.g, IP address) identifying the client device. If the IP address of the client device corresponds to the first network environment (e.g., office network), the application firewall manager may determine that the location of the client device corresponds to the first network environment. Otherwise, the application firewall manager may determine that the client device is located in the second network environment that is less secure than the first network environment.

The application firewall manager may, in some embodiments, be configured to determine one or more firewall rules based on the location (e.g, first network environment or second network environment) of the client device as well as a firewall policy created for the VDI system by an authorized individual (e.g., internet technology professional). For example, the firewall policy may indicate that a first application having access to proprietary information is only accessible when the client device connects to the VDI system from the first network environment (e.g., office network). Additionally, the firewall policy may indicate that the client device may access a second application that does not have access to proprietary information regardless of the location (e.g., first network environment or second network environment) of the client device when connecting to the VDI system. Stated another way, the firewall policy may indicate that the client device may access the second application from the second network environment (e.g., non-office network environment) that is less secure than the first network environment (e.g., office network environment).

The VDI system may, in some embodiments, include a network manager configured to generate a firewall for the VDI system, specifically the virtual machine hosting the virtual desktop assigned to the client device, based, at least in part, on the firewall rule(s) created by the application firewall manager. For instance, the network manager may configure various hardware and/or software components of the data center to generate the firewall based on the firewall rule(s). Furthermore, in some embodiments, the network manager may be configured to remove (e.g., delete) the firewall when the client device disconnects from the VDI system and is therefore no longer logged into one of the virtual desktops hosted by the virtual machine of the VDI system. In this manner, a firewall may be created for the client device each time the client device connects to the VDI system to access one of the virtual desktops hosted by the VDI system.

Example aspects of the present disclosure provide numerous technical effects and benefits. For instance, a VDI system according to example aspects of the present disclosure does not require multiple pools of virtual desktops to accommodate each of the different locations (e.g., network environments) from which client devices may connect to the VDI system. As a result, the VDI system according to example aspects of the present disclosure does not require multiple firewall policies, one for each of the different pools of virtual desktops like required by conventional VDIs. Accordingly, embodiments of the present disclosure avoid the complexity and additional utilization of computing resources that would otherwise be associated with creating and maintaining multiple pools of virtual desktops and multiple firewall policies associated with such pools (e.g., including avoiding the utilization of computing resources associated with enforcing multiple firewall policies). Furthermore, the VDI system according to example aspects of the present disclosure removes (e.g., deletes) the firewall each time the client device disconnects from the VDI system and determines new firewall rules when the client device reconnects to the VDI system so that the firewall accounts for movement (e.g., from the first network environment to the second network environment or vice versa) of the client device that may occur between the client device disconnecting from the VDI system and reconnecting to the VDI system.

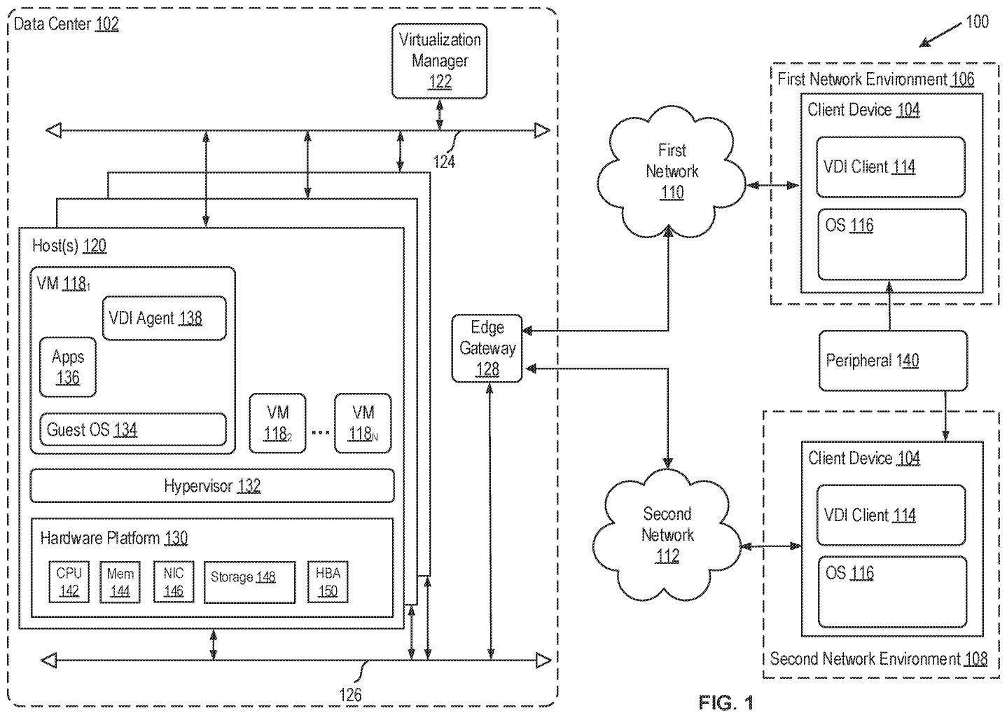

FIG. 1 depicts a block diagram of a virtualized desktop infrastructure (VDI) system 100 in which one or more embodiments according to the present disclosure may be implemented. The VDI system 100 includes a data center 102. As shown, a client device 104 may be connected to the VDI system 100, specifically the data center 102 thereof, from different network environments. For example, the client device 104 may connect to the data center 102 from a first network environment 106 (e.g., office network) or a second network environment 108 (e.g., non-office network) that is less secure than the first network environment 106. When the client device 104 is in the first network environment 106, the client device 104 may connect to the data center 102 via a first network 110 (e.g., wired or wireless) associated with the first network environment 106. Conversely, when the client device 104 is in the second network environment 108, the client device 104 may connect to the data center 102 via a second network 112 (e.g., wired or wireless) associated with the second network environment 108.

It should be appreciated that the first network 110 and the second network 106 may be, for example, a direct link, a local area network (LAN), a wide area network (WAN) such as the Internet, another type of network or a combination of these.

The client device 104 may be a physical device, such as a general purpose desktop computer or mobile computer. A mobile computer may be, for example, a laptop, a mobile phone, or a tablet computer. The client device 104 may include a VDI client 114, and an operating system (OS) 116. In some embodiments, the VDI client 114 may run on top of the OS 116 which may be a standard, commodity operating system.

The VDI client 114 is a user-side interface of a virtualized desktop running on one of virtual machines (VMs) 118. Though certain aspects are described herein with respect to a virtual desktop running on a VM, the techniques may similarly be used for a virtual desktop or application running on other types of VDIs, such as containers, or on physical computing devices. As used herein, a “virtualized desktop” or “remote desktop” is a desktop running on, for example, one of VMs 118 that is displayed remotely on the client device 104, as though the remote desktop were running on the client device 104. By opening the VDI client 114, a user of the client device 104 may access, through a network (e.g, first network 110 or second network 112), a remote desktop running in the data center 102, from any location, using the client device 104. Frames of the remote desktop running on one of the VMs 118 may be transmitted to the VDI client 114 using a desktop delivery protocol such as VMware® Blast™, or Microsoft® Remote Desktop Protocol (RDP)™.

After transmission, the frames are displayed on the client device 104 for interaction by the user. The client device 104 may send user inputs to the VM 118 for processing on the VM 118 of the data center 102, taking processing load off the client device 104. Such centralized and automated management of remote desktops provides increased control and cost savings. The VDI client 114 may be, for example, VMware® View™, or a special purpose thin client such as those available from Dell, HP, NEC, Sun Microsystems, Wyse, and others.

The data center 102 includes hosts 120, a virtualization manager 122, a management network 124, a data network 126, and an edge gateway 128. Although the management and data network are shown as separate physical networks, it is also possible in some implementations to logically isolate the management network from the data network using different VLAN identifiers. Each of the hosts 120 may be constructed on a server grade hardware platform 130, such as an x86 architecture platform. For example, the hosts 120 may be geographically co-located servers on the same rack.

The hosts 120 are configured to provide a virtualization layer, also referred to as a hypervisor 132, that abstracts processor, memory, storage, and networking resources of hardware platform 130 into multiple VMs 118₁ to 118_{N} (collectively referred to as VMs 118 and individually referred to as VM 118) that run concurrently on the same host 120. The hypervisor 132 may run on top of the operating system in the hosts 120. In some embodiments, the hypervisor 132 may be installed as system level software directly on the hardware platform 130 of the hosts 120 (often referred to as “bare metal” installation) and be conceptually interposed between the physical hardware and the guest operating systems executing in the virtual machines. In some implementations, the hypervisor 132 may include system level software as well as a “Domain 0” or “Root Partition” virtual machine, which is a privileged machine that has access to the physical hardware resources of the host. In this implementation, one or more of a virtual switch, virtual tunnel endpoint (VTEP), etc., along with hardware drivers, may reside in the privileged virtual machine. Although the disclosure is described with reference to VMs, the teachings herein also apply to other types of virtual computing instances (VCIs), such as containers, Docker containers, data compute nodes, isolated user space instances, namespace containers, and the like. One example of the hypervisor 132 that may be used is a VMware ESXi™ hypervisor provided as part of the VMware vSphere® solution made commercially available from VMware, Inc. of Palo Alto, California.

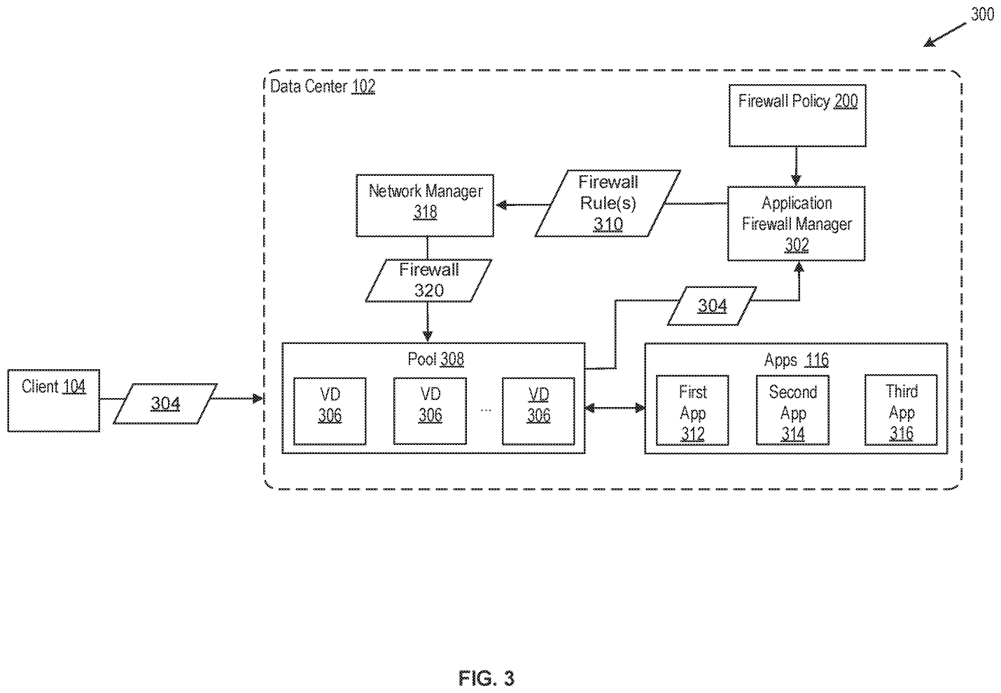

Each VM 118 includes a guest OS 134, applications 136, and a VDI agent 138. The applications 136 and the VDI agent 138 may run on top of the guest OS 134 which, in some embodiments, may be a standard, commodity operating system. It should be appreciated that the applications 136 may be any software program. For example, in some embodiments, one or more of the software programs may have access to proprietary data which, as will be discussed in more detail below with reference to FIG. 3, may be vulnerable to malware or other unauthorized software.

The VDI agent 138 may be a desktop virtualization program that connects to the VDI client 114 of the client device 104, through the first network 110 or the second network 112. The connection between the VDI agent 138 and the VDI client 114 may be authenticated, such as through a username and password combination pertaining to the client device 104 or to an individual using the client device 104. The VDI agent 138 may transmit, to the VDI client 114, one or more image frames of the remote desktop running on the VM 118 that includes the VDI agent 138. The image frame(s) may include information (e.g., pixel color, location information) on appearance of the remote desktop running on the VM 118. In addition to the image frame(s), the VDI agent 138 may also transmit metadata of that frame to the VDI client 114. The metadata may include x and y coordinate locations of a mouse cursor, x and y coordinates and size of windows of the applications 136 open on the remote desktop, which of the applications 136 are running on and/or displayed on the remote desktop of the VM 118, and other information.

The VDI agent 138 may also receive data from the VDI client 114 of the client device 104. For instance, user input generated by a user interacting with a peripheral 140 (e.g., mouse, keyboard) to control the virtual desktop on the VM 118 may be redirected to the VDI agent 138 via the VDI client 114.

The hardware platform 130 of each host 120 includes components of a computing device such as one or more processors (CPUs) 142, system memory 144, a network interface 146, storage system 148, a host bus adapter (HBA) 150, and other I/O devices such as, for example, a mouse and keyboard (not shown). The CPU(s) 142 are configured to execute instructions, for example, executable instructions that perform one or more operations described herein and that may be stored in the memory 144 and in the storage system 148. The network interface 146 enables the hosts 120 to communicate with other devices via a communication medium, such as the management network 124 or the data network 126. The network interface 146 may include one or more network adapters, also referred to as Network Interface Cards (NICs). The storage system 148 represents persistent storage devices (e.g., one or more hard disks, flash memory modules, solid state disks, and/or optical disks). The HBA 150 couples each host 105 to one or more external storages (not shown), such as a storage area network (SAN). Other external storages that may be used include network-attached storage (NAS) and other network data storage systems, which may be accessible via the network interface 146.

The system memory 144 is hardware allowing information, such as executable instructions, configurations, and other data, to be stored and retrieved. The memory 144 is where programs and data are kept when the CPU 142 is actively using them. The memory 144 may be volatile memory or non-volatile memory. Volatile or non-persistent memory is memory that needs constant power in order to prevent data from being erased. Volatile memory describes conventional memory, such as dynamic random access memory (DRAM). Non-volatile memory is memory that is persistent (non-volatile). Non-volatile memory is memory that retains its data after having power cycled (turned off and then back on). Non-volatile memory is byte-addressable, random access non-volatile memory.

The virtualization manager 122 communicates with the hosts 105 via a network (e.g., the management network 124) and carries out administrative tasks for the data center 102 such as managing the hosts 120, managing the VMs 118 running within each host 120, provisioning VMs, migrating VMs from one host to another host, and load balancing between the hosts 120. The virtualization manager 122 may be a computer program that resides and executes in a central server in the data center 102 or, alternatively, the virtualization manager 122 may run as a virtual appliance (e.g., a VM) in one of the hosts 105. One example of a virtualization manager is the vCenter Server™ product made available from VMware, Inc.

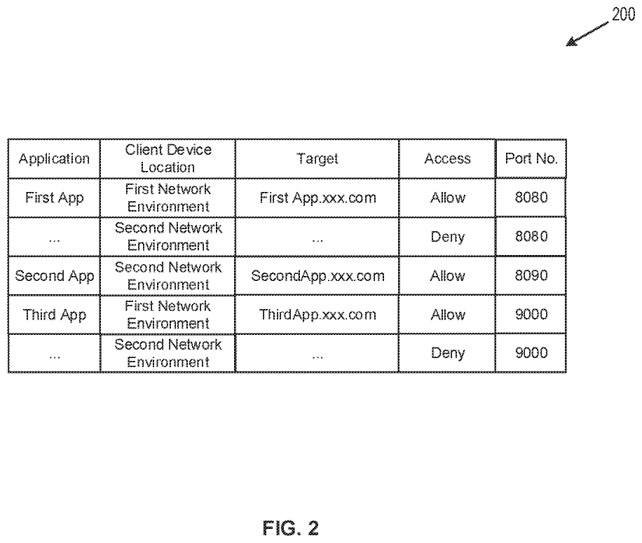

FIG. 2 depicts a firewall policy 200 for a VDI system according to some embodiments of the present disclosure. For simplicity, the firewall policy 200 will be discussed in the context of the VDI system 100 discussed above with reference to FIG. 1. It should be appreciated, however, that the firewall policy 200 may be used with any suitable VDI system hosting virtual desktops that can be accessed by client devices from multiple locations.

The firewall policy 200 (e.g., illustrated as a table) may specify which of the applications 136 associated with a virtual desktop running on the VM 118₁ are accessible based on the location of the client device 104 when connecting to one of the hosts 120 to access the virtual desktop. For instance, the firewall policy 200 allows the client device 104 to access a first application (e.g., First App) and a third application (e.g., Third App) only when the client device 104 connects to one of the hosts 120 from the first location (e.g., office) and via the first network environment 106 (e.g., office network) associated with the first location. Furthermore, the firewall policy 200 allows the client device 104 to access the second application (e.g., Second App) from the second location (e.g, hotel, airport, home) and via the second network environment 112 associated with the second location.

In some embodiments, the firewall policy 200 may specify which ports the client device 104 may communicate with the applications 136 associated with the virtual desktop. For example, the firewall policy 200 specifies that the client device 104 may communicate with the first application of the applications 136 via a first port (e.g., port 8080 in FIG. 2). Furthermore, the firewall policy 200 specifies that the client device 104 may communicate with the second and third applications via a second port (e.g, port 8090 in FIG. 2) and a third port (e.g., port 9000 in FIG. 2), respectively.

In some embodiments, the firewall policy 200 may specify a target for each of the applications 136. For example, a target for the first application of the applications 136 may, as shown, be FirstApp.xxx.com. A target for the second and third applications may be SecondApp.xxx.com and ThirdApp.xxx.com, respectively. It should be appreciated that the client device 104 may access the different applications via the corresponding target included in the firewall policy.

FIG. 3 depicts a system 300 for implementing a location based firewall policy (such as the firewall policy 200 in FIG. 2) for a VDI system according to some embodiments of the present disclosure. The system 300 will be discussed with reference to the VDI system discussed above with reference to FIG. 1. However, it should be appreciated that the system 300 may be implemented in any suitable VDI system.

The system 300 may include an application firewall manager 302 configured to determine a location (e.g., network environment) of the client device 104 based on information 304 identifying the client device 104 that is connected to one of a plurality of virtual desktops 306 included in a pool 308 of virtual desktops hosted by the data center 102. In some embodiments, the information 304 may include the IP address of the client device 104. Furthermore, in some embodiments, the application firewall manager 302 may obtain the IP address of the client device 104 from the VDI agent 138 (FIG. 1) of the virtual desktop 306 to which the client device 104 is connected.

If the IP address of the client device 104 corresponds to the first network environment 106 (FIG. 1), the application firewall manager 302 may determine that the client device 104 is in the first network environment 106. Otherwise, the application firewall manager 302 may determine that the client device 104 is in the second network environment 108 (FIG. 1) that is less secure than the first network environment 106.

In some embodiments, the application firewall manager 302 may be configured to determine one or more firewall rules 310 based on the location (e.g, first network environment 106 or second network environment 108) of the client device 104 as well as the firewall policy 200. For example, as previously discussed with reference to FIG. 2, the firewall policy 200 may indicate that two applications (e.g., first application 312 and third application 316) of the applications 136 associated with the virtual desktop 306 and having access to proprietary information (e.g., financial data, sales data, etc.) are only accessible when the client device 104 connects to the virtual desktop 306 from the first network environment 106 (e.g., office network). Additionally, the firewall policy 200 may indicate that another (e.g, second application 314) of the application 136 that does not have access to proprietary information is accessible regardless of the location of the client device 104. Stated another way, the firewall policy 200 may specify that the client device 104 may access the second application 314 even when the client device 104 is in the second network environment 108 (e.g., non-office network environment) that is less secure than the first network environment 106 (e.g., office network environment).

The system 300 may include a network manager 318 configured to generate a firewall 320 based, at least in part, on the firewall rule(s) 310 created by the application firewall manager 302. For instance, the network manager 318 may configure various hardware and/or software components of the data center 102 to generate the firewall 320 based on the firewall rule(s) 310. Furthermore, in some embodiments, the network manager 318 may be configured to delete the firewall 320 when the client device 104 disconnects from the data center 102 and is therefore no longer assigned to one of the virtual desktops 306 included in the pool 308 hosted on the data center 102. In this manner, the firewall policy 200 may be created for the client device 104 each time the client device 104 connects to one of the virtual desktops 306 included in the pool 308.

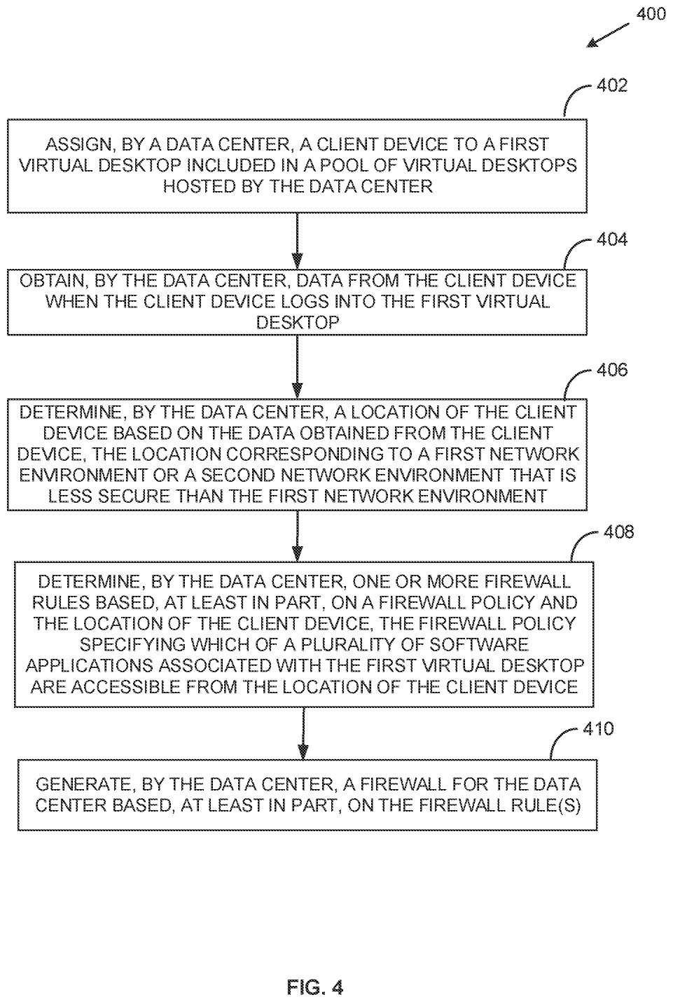

FIG. 4 illustrates example operations 400 related to a method for implementing a location based firewall policy for a VDI system including a data center hosting a pool of virtual desktops according to some embodiments of the present disclosure. For example, operations 400 may be performed by the system 300 discussed above with reference to FIG. 3.

Operation 400 may include assigning, by a data center, a client device to a first virtual desktop included in the pool of virtual desktops.

Operation 402 may include obtaining, by the data center, data from the client device when the client device logs into the first virtual desktop to which the client device was assigned at operation 400. For instance, in some embodiments, the data from the client device may include an IP address of the client device. Furthermore, in some embodiments, the data from the client device may be obtained via a VDI agent of the first virtual desktop.

Operation 406 may include determining, by the data center, a location of the client device based, at least in part, on the data obtained from the client device. For example, determining the location of the client device may include determining based, at least in part, on the data obtained from the client device that the location of the client device corresponds to a first network environment (e.g., office network) or a second network environment (e.g., non-office environment) that is less secure than the first network environment. Furthermore, in some embodiments, operation 406 may be performed by an application firewall manager that is included in the data center.

Operation 408 may include determining, by the data center, one or more firewall rules based, at least in location of the client device as determined at operation 406. For example, the firewall policy for the VDI system may indicate that a first application of the applications associated with the virtual desktop and having access to proprietary information (e.g., financial data, sales data, etc.) is only accessible when the client device connects to the virtual desktop from the first network environment (e.g., office network). Additionally, the firewall policy may indicate that a second application of the applications that does not have access to proprietary information is accessible regardless of the location of the client device. Stated another way, the firewall policy may specify that the client device may access the second application even when the client device is in the second network environment (e.g., non-office network environment) that is less secure than the first network environment (e.g., office network environment).

Operation 410 may include generating, by the data center, a firewall for the data center based, at least in part, on the one or more firewall rules determined at operation 408. For instance, in some embodiments, generating the firewall may include applying, by the data center, the firewall to a virtual machine of the data center and on which the first virtual desktop is running.

In certain embodiments, operations may further include determining, by the data center, that the client device has disconnected from the data center. For instance, in some embodiments, determining that the client device has disconnected from the data center may include determining, by the data center, that the client device has logged out of the first virtual desktop and is therefore no longer connected to the virtual machine hosting the first virtual desktop.

In certain embodiments, the operations may further include removing, by the data center, the firewall generated at operation 410. More specifically, removing (e.g., deleting) the firewall may occur in response to determining that the client device has disconnected from the data center.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments according to the present disclosure may be useful machine operations. In addition, one or more embodiments according to the present disclosure also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments according to the present disclosure may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. —The computer readable medium can also be distributed over a network coupled computer system so that the computer readable code is stored and executed in a distributed fashion.

Although one or more embodiments according to the present disclosure have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers, each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless of the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for implementing a firewall policy for a virtual desktop infrastructure (VDI) system comprising a data center hosting a pool of virtual desktops, the method comprising:
assigning, by the data center, a client device to a first virtual desktop included in the pool of virtual desktops hosted by the data center;
obtaining, by the data center, data from the client device when the client device logs into the first virtual desktop;
determining, by the data center, a location of the client device based, at least in part, on the data obtained from the client device, the location corresponding to a first network environment or a second network environment that is less secure than the first network environment;
determining, by the data center, one or more firewall rules based, at least in part, on the firewall policy and the location of the client device, wherein the firewall policy specifies which of a plurality of software applications associated with the first virtual desktop are accessible from the location of the client device; and
generating, by the data center, a firewall for the data center based, at least in part, on the one or more firewall rules.

2. The method of claim 1, wherein when the location of the client device corresponds to the second network environment, the determining the one or more firewall rules comprises:
determining, by the data center, the firewall policy prohibits the client device from accessing a first software application of the plurality of software applications from the second network environment; and
generating, by the data center, a first firewall rule prohibiting the client device from accessing the first software application.

3. The method of claim 2, wherein the first software application has access to proprietary information.

4. The method of claim 1, further comprising:
determining, by the data center, the client device has disconnected from the data center; and
removing, by the data center, the firewall from the data center.

5. The method of claim 4, wherein the determining the client device has disconnected from the data center comprises determining, by the data center, that the client device has logged off of the first virtual desktop included in the pool of virtual desktops hosted by the data center.

6. The method of claim 1, wherein:
the client device is assigned to an individual of an entity;
the first network environment comprises a first location associated with the entity; and
the second network environment comprises a second location that is not associated with the entity.

7. The method of claim 1, wherein generating the firewall comprises applying, by the data center, the firewall to a virtual machine of the data center, wherein the first virtual desktop is running on the virtual machine.

8. The method of claim 1, wherein obtaining the data from the client device comprises obtaining, via a VDI agent of the first virtual desktop, the data from the client device.

9. The method of claim 8, wherein the data from the client device comprises an internet protocol (IP) address of the client device.

10. A system for implementing a firewall policy for a virtual desktop infrastructure (VDI) system comprising a data center hosting a pool of virtual desktops, the system comprising:
at least one memory; and
at least one processor coupled to the at least one memory, the at least one processor and the at least one memory configured to:
assign a client device to a first virtual desktop included in the pool of virtual desktops hosted by the data center;
obtain data from the client device when the client device logs into the first virtual desktop;
determine a location of the client device based, at least in part, on the data obtained from the client device, the location corresponding to a first network environment or a second network environment that is less secure than the first network environment;
determine one or more firewall rules based, at least in part, on the firewall policy and the location of the client device, wherein the firewall policy specifies which of a plurality of software applications associated with the first virtual desktop are accessible from the location of the client device; and
generate a firewall for the data center based, at least in part, on the one or more firewall rules.

11. The system of claim 10, wherein when the location of the client device corresponds to the second network environment, to determine the one or more firewall rules the at least one memory and the at least one processor are configured to:
determine the firewall policy prohibits the client device from accessing a first software application of the plurality of software applications from the second network environment; and
generate a first firewall rule prohibiting the client device from accessing the first software application.

12. The system of claim 11, wherein the first software application has access to proprietary information.

13. The system of claim 10, wherein the at least one memory and the at least one processor are further configured to:
determine the client device has disconnected from the data center; and
remove the firewall from the data center.

14. The system of claim 13, wherein the determining the client device has disconnected from the data center comprises determining, by the data center, that the client device has logged off of the first virtual desktop.

15. The system of claim 10, wherein:
the client device is assigned to an individual of an entity;
the first network environment comprises a first location associated with the entity; and
the second network environment comprises a second location that is not associated with the entity.

16. The system of claim 15, wherein the second location comprises an airport, a personal residence, or a hotel.

17. The system of claim 10, wherein to obtain the data from the client device, the at least one memory and the at least one processor are configured to obtain, via a VDI agent of the first virtual desktop, the data from the client device.

18. The system of claim 17, wherein the data from the client device comprises an internet protocol (IP) address of the client device.

19. The system of claim 10, wherein to generate the firewall for the data center, the at least one memory and the at least one processor are configured to apply the firewall to a virtual machine of the data center, and wherein the first virtual desktop is running on the virtual machine.

20. A non-transitory computer-readable medium storing instructions that, when executed by one or more processors, cause the one or more processors to:
assign, by a data center hosting a pool of virtual desktops, a client device to a first virtual desktop included in the pool of virtual desktops hosted by the data center;
obtain, by the data center, data from the client device when the client device logs into the first virtual desktop;
determine, by the data center, a location of the client device based, at least in part, on the data obtained from the client device, the location corresponding to a first network environment or a second network environment that is less secure than the first network environment;
determine, by the data center, one or more firewall rules based, at least in part, on a firewall policy and the location of the client device, wherein the firewall policy specifies which of a plurality of software applications associated with the first virtual desktop are accessible from the location of the client device;
generate, by the data center, a firewall for the data center based, at least in part, on the one or more firewall rules; and
apply, by the data center, the firewall to the data center.
